(19) United States
(12) Patent Application Publication
(10) Pub. No.: US 2020/0305220 A1
(43) Pub. Date: Sep. 24, 2020

(54) RADIO ACCESS NETWORK NODE, RADIO TERMINAL, NETWORK NODE, AND METHOD THEREFOR

(71) Applicant: NEC Corporation, Minato-ku, Tokyo (JP)

(72) Inventor: Takanori IWAI, Tokyo (JP)

(73) Assignee: NEC Corporation, Minato-ku, Tokyo (JP)

(21) Appl. No.: 16/088,120

(22) PCT Filed: Jan. 30, 2017
(86) PCT No.: PCT/JP2017/003166

§ 371 Date: Sep. 25, 2018

(30) Foreign Application Priority Data
Mar. 31, 2016 (JP) 2016-072423

(51) Int. Cl. H04W 76/25; H04W 72/10; H04W 76/27; H04W 28/02

(52) U.S. Cl. CPC H04W 76/25; H04W 28/0257; H04W 76/27; H04W 72/10

(57) ABSTRACT

A radio access network node (2) reduces a priority parameter of at least one control logical channel of a radio terminal (1), used for transmission of a control message between the radio access network node (2) and the radio terminal (1), from its initial value in response to a predetermined event. The priority parameter affects priority handling among logical channels of the radio terminal (1) performed in at least one of the radio access network node (2) and the radio terminal (1). The logical channels include the at least one control logical channel and at least one data logical channel used for transmission of user data of the radio terminal (1). It is thus, for example, possible to enable a base station or a radio terminal to change behavior for resource allocation for U-plane traffic and C-plane traffic.

### TECHNICAL FIELD

The present disclosure relates to a mobile communication network and, in particular, to priority handling among a plurality of logical channels (or radio bearers).

### BACKGROUND ART

Non-patent Literature 1 describes Medium Access Control (MAC) functions of LTE. Non-patent Literature 2 describes Radio Resource Control (RRC) functions of LTE. Note that the term “LTE” used in this specification means LTE (3GPP Release 8 and later), LTE-Advanced (3GPP Release 10 and later), and LTE-Advanced Pro (3GPP Release 13 and later), unless otherwise specified.

Logical channels include control logical channels associated with Signaling Radio Bearer (SRBs) and data logical channels associated with Data Radio Bearer (DRBs). Each logical channel is associated with one Radio Bearer (RB) on a one-to-one basis. LTE control logical channels include a Common Control Channel (CCCH) and a Dedicated Control Channel (DCCH). The CCCH is used for SRB0 and the DCCH is used for SRB1 and SRB2. The SRB0 is used to transmit RRC messages for establishing or reestablishing an RRC connection. The SRB1 is used to transmit RRC messages and to transmit Non-Access Stratum (NAS) messages before the SRB2 is established. The SRB2 is used to transmit RRC messages including logged measurement information and to transmit NAS messages.

The LTE MAC functions include dynamic packet scheduling to schedule transmissions of UEs, and also include multiplexing of a plurality of logical channels (i.e., MAC Service Data Units (SDUs), or Radio Link Control Protocol (RLC) PDUs) to generate a transport block (i.e., a MAC Protocol Data Unit (PDU)). In the packet scheduling and the multiplexing, priorities and Prioritized Bit Rates assigned to respective logical channels (i.e., radio bearers) are taken into account.

Non-patent Literature 1 specifies a Logical Channel Prioritization (LCP) procedure in a radio terminal (i.e., User Equipment (UE)). In the LCP procedure, a priority and a PBR of each logical channel are taken into account. The PBR is a bit rate provided to one logical channel before allocating any resources to a lower-priority logical channel. The LCP procedure includes the first round and the second round. In the first round, for every logical channel, resources corresponding to the PBR are allocated in descending order of their priorities. The upper limit for resources allocated to each logical channel in the first round is equal to a bucket size of that logical channel. The bucket size of each logical channel is a value obtained by multiplying the PBR by a bucket size duration (BSD). Next, in the second round, when there are remaining available resources even after the resources corresponding to the PBRs are provided to all the logical channels, the remaining resources are allocated to data of the logical channels in descending order of their priorities until no data of these logical channels remains or resources to be allocated are all used up.

The uplink (UL) scheduling, the downlink (DL) scheduling, and the LCP to generate a downlink transport block (i.e., a DL MAC PDU), which are performed by a base station (i.e., eNodeB (eNB)), are left to the eNB implementation. Therefore, Non-patent Literature 1 does not specify these matters. In some implementations, the eNB considers priorities and PBRs of logical channels of UEs to schedule UL (or DL) transmission of these UEs. For example, the eNB preferentially allocates radio resources to data transmission of a higher-priority logical channel over data transmission of a lower-priority logical channel. Additionally or alternatively, in some implementations, the eNB considers priorities and PBRs of logical channels of one UE to multiplex these logical channels to generate a DL transport block (i.e., a DL MAC PDU) addressed to this UE, as in the case of the LCP procedure performed by the UE.

The RRC layer configures priorities and PBRs of radio bearers (or logical channels) in the MAC layer, and the MAC layer performs priority handling among the logical channels according to the priorities and the PBRs configured by the RRC layer. Non-patent Literature 2 specifies priorities of SRB0 (i.e., CCCH), SRB1 (i.e., DCCH), and SRB2 (i.e., DCCH). Specifically, the priorities of SRB0 (i.e., CCCH), SRB1 (i.e., DCCH), and SRB2 (i.e., DCCH) are 1, 1, and 3, respectively. The value of a priority is an integer from 1 to 16. Further, the smaller the value, the higher the priority. That is, SRB0 and SRB1 have the highest priority, and SRB2 has a reduce priority than SRB0 and SRB1. Further, the PBRs of SRB0 (i.e., CCCH), SRB1 (i.e., DCCH), and SRB2 (i.e., DCCH) are all “infinity”. If the PBR of a logical channel (or a radio bearer) is set to “infinity”, a MAC entity of the UE shall allocate resources to all the data of this logical channel that is available for transmission before meeting the PBRs of lower-priority logical channels.

The priority and the PBR of a DRB (i.e., DTCH) are derived from Quality of Service (QoS) of its corresponding Evolved Packet System (EPS) bearer. Specifically, the priority and the PBR of a DRB (i.e., DTCH) are derived from the Quality Class Indicator (QCI) priority and the Guaranteed Bit Rate (GBR) of its corresponding EPS bearer. Note that a specific procedure for obtaining the priority and the PBR of a DRB (i.e., DTCH) is left to the eNB implementation, and therefore Non-patent Literature 2 does not specify these matters. In general, however, SRBs (i.e., CCCH and DCCH) have a higher priority than DRB (i.e., DTCH).

### CITATION LIST

### Non Patent Literature

Non-patent Literature 1: 3GPP TS 36.321 V13.0.0 (2015-12), “3rd Generation Partnership Project; Technical Specification Group Radio Access Network; Evolved Universal Terrestrial Radio Access (E-UTRA); Medium Access Control (MAC) protocol specification (Release 13)”, December 2015

Non-patent Literature 2: 3GPP TS 36.331 V13.0.0 (2015-12), “3rd Generation Partnership Project; Technical Specification Group Radio Access Network; Evolved Universal Terrestrial Radio Access (E-UTRA); Radio Resource Control (RRC); Protocol specification (Release 13)”, December 2015

### SUMMARY OF INVENTION

### Technical Problem

As described above, in LTE, SRB0 and SRB1 are given the highest priority. Further, SRB2 is also given a higher priority level than the DRB. Accordingly, SRBs are given radio resources preferentially over DRBs according to the priority handling among logical channels performed by the eNB and the UE, and thus are transmitted preferentially over DRBs.

The inventor has found that in some cases, it is effective to adjust the priorities or the PBRs of SRBs that are taken into account in the priority handling among logical channels in the eNB or the UE. For example, it may be preferable if an eNB or a core network can facilitate resource allocation for user data (i.e., user plane (U-plane) traffic). Alternatively, it may be preferable if an eNB or a core network can reduce control plane (C-plane) traffic (i.e., RRC messages and NAS messages). To meet these needs, it may be effective to change the priorities or the PBRs of SRBs, for example, to make the priorities of SRBs equal to or lower than the priority priorities of DRBs.

One of the objects to be attained by embodiments disclosed herein is to provide an apparatus, a method, and a program that contribute to enabling a base station or a radio terminal to change behavior for resource allocation for U-plane traffic and C-plane traffic. It should be noted that the above-described object is merely one of the objects to be attained by the embodiments disclosed herein. Other objects or problems and novel features will be made apparent from the following description and the accompanying drawings.

### Solution to Problem

In a first aspect, a radio access network node includes a memory, and at least one processor coupled to the memory. The at least one processor is configured to reduce a priority parameter of at least one control logical channel of a first radio terminal from an initial value in response to a predetermined event. The at least one control logical channel is used for transmission of a control message between the radio access network node and the first radio terminal. The priority parameter affects priority handling among a plurality of logical channels of the first radio terminal performed in at least one of the radio access network node and the first radio terminal. The plurality of logical channels include the at least one control logical channel and at least one data logical channel of the first radio terminal used for transmission of user data of the first radio terminal.

In a second aspect, a method performed in a radio access network node includes: (a) determining an occurrence of a predetermined event; and (b) in response to the predetermined event, reducing a priority parameter of at least one control logical channel of a first radio terminal from an initial value, the at least one control logical channel being used for transmission of a control message between the radio access network node and the first radio terminal.

In a third aspect, a radio terminal includes a memory, and at least one processor coupled to the memory. The at least one processor is configured to receive from a radio access network node a signalling message indicating that a priority parameter of at least one control logical channel used for transmission of a control message between the radio terminal and the radio access network node is to be reduced from an initial value. The at least one processor is further configured to apply the reduced priority parameter to priority handling among a plurality of logical channels of the radio terminal performed in the radio terminal.

In a fourth aspect, a method performed in a radio terminal includes: (a) receiving from a radio access network node a signalling message indicating that a priority parameter of at least one control logical channel used for transmission of a control message between the radio terminal and the radio access network node is to be reduced from an initial value; and (b) applying the reduced priority parameter to priority handling among a plurality of logical channels of the radio terminal performed in the radio terminal.

In a fifth aspect, a network node includes a memory, and at least one processor coupled to the memory. The at least one processor is configured to transmit a first signalling message to a base station. The first signalling message triggers the base station to reduce a priority parameter of at least one control logical channel of a first radio terminal, used for transmission of a control message between the base station and the first radio terminal, from an initial value.

In a sixth aspect, a method performed in a network node includes transmitting a first signalling message to a base station. The first signalling message triggers the base station to reduce a priority parameter of at least one control logical channel of a first radio terminal, used for transmission of a control message between the base station and the first radio terminal, from an initial value.

In a seventh aspect, a program includes a set of instructions (software codes) that, when loaded into a computer, causes the computer to perform a method according to the above-described second, fourth or sixth aspect.

### Advantageous Effects of Invention

According to the above-described aspects, it is possible to provide an apparatus, a method, and a program that contribute to enabling a base station or a radio terminal to change behavior for resource allocation for U-plane traffic and C-plane traffic.

### BRIEF DESCRIPTION OF DRAWINGS

FIG. 1 shows a configuration example of a mobile communication network according to some embodiments;

FIG. 2 is a flowchart showing an example of an operation performed by an eNB according to a first embodiment;

FIG. 3 is a sequence diagram showing an example of operations performed by a UE and an eNB according to the first embodiment;

FIG. 4 is a flowchart showing an example of an operation performed by a UE according to the first embodiment;

FIG. 5 is a block diagram showing a configuration example of an eNB according to the first embodiment;

FIG. 6 is a block diagram showing a configuration example of a UE according to the first embodiment;

FIG. 7 is a sequence diagram showing an example of operations performed by an eNB and a network node according to a second embodiment;

FIG. 8 is a flowchart showing an example of an operation performed by a network node according to the second embodiment;

FIG. 9 is a sequence diagram showing an example of operations performed by an eNB and a network node according to the second embodiment;

FIG. 10 shows a configuration example of an eNB according to some embodiments;

FIG. 11 shows a configuration example of a UE according to some embodiments; and

FIG. 12 shows a configuration example of a network node according to some embodiments.

### DESCRIPTION OF EMBODIMENTS

Specific embodiments will be described hereinafter in detail with reference to the drawings. The same or corresponding elements are denoted by the same symbols throughout the drawings, and duplicated explanations are omitted as necessary for the sake of clarity.

The following embodiments will be described on the assumption that they are implemented for LTE. However, these embodiments are not limited to LTE and may also be applied to other mobile communication networks or systems such as 3rd Generation Partnership Project (3GPP) Universal Mobile Telecommunications System (UMTS), 3GPP2 CDMA2000 system, Global System for Mobile communications (GSM (Registered Trademark))/General packet radio service (GPRS) system, WiMAX system, and Mobile WiMAX system.

### First Embodiment

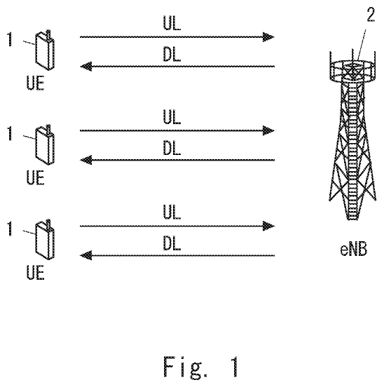

FIG. 1 shows a configuration example of a mobile communication network according to some embodiments including this embodiment. In the example shown in FIG. 1, the mobile communication network includes UEs 1 and an eNB 2. The eNB 2 is disposed in a Radio Access Network (RAN) and is configured to communicate with a plurality of UEs 1 connected to the RAN and provide radio resource management for these UEs 1. The radio resource management includes for example: establishment, modification, and release of a radio connection (e.g., a Radio Resource Control (RRC) connection) with each UE 1; scheduling (i.e., radio resource allocation) for downlink transmission and uplink transmission of each UE 1; and control of a handover of each UE 1. The eNB 2 shown in FIG. 1 may be a macrocell base station or a femtocell base station.

The eNB 2 shown in FIG. 1 may be a Baseband Unit (BBU) used in a Centralized Radio Access Network (C-RAN) architecture. In other words, the eNB 2 shown in FIG. 1 may be a RAN node connected to one or more Remote Radio Heads (RRHs). In some implementations, the eNB 2 serving as a BBU is connected to a core network (i.e., an Evolved Packet Core (EPC)) and is responsible for control-plane processing including radio resource management and for digital baseband signal processing for the user plane. Meanwhile, the RRU is responsible for analog Radio Frequency (RF) signal processing (e.g., a frequency conversion and signal amplification). The C-RAN may also be referred to as a Cloud RAN. The BBU may also be referred to as a Radio Equipment Controller (REC) or a Data Unit (DU). The RRH may also be referred to as a Radio Equipment (RE), a Radio Unit (RU), or a Remote Radio Unit (RRU).

Further, there is another C-RAN architecture in which a part of the baseband signal processing is arranged in the remote site. In some implementations, layer-1 (i.e., physical layer) baseband signal processing may be located in the remote site, and layer-2 (i.e., MAC sublayer, RLC sublayer, and Packet Data Convergence Protocol (PDCP) sublayer) and layer-3 signal processing may be located in the central site. In some implementations, the layer-1 signal processing and a part or all of the layer-2 signal processing may be located in the remote site, and the layer-3 signal processing may be located in the central site. The eNodeB 2 shown in FIG. 1 may be a data unit located in the central site in these C-RAN architectures.

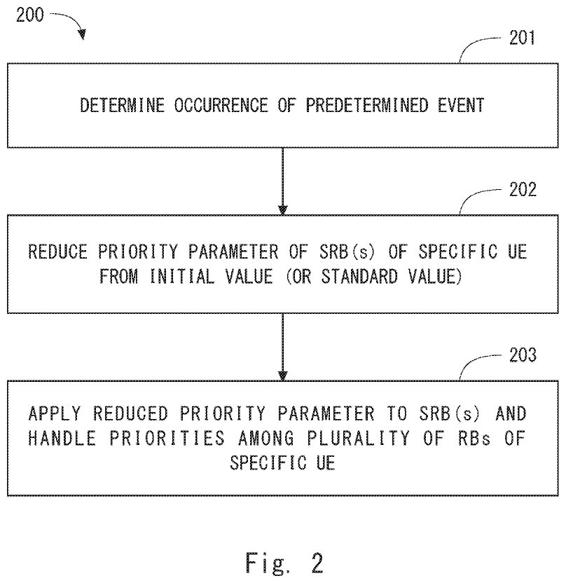

The following provides details of an operation performed by the eNB 2 according to this embodiment. FIG. 2 is a flowchart showing a process 200 that is an example of an operation performed by the eNB 2. In step 201, the eNB 2 determines (or detects) an occurrence of a predetermined event. The occurrence of the predetermined event triggers the eNB 2 to perform processes in steps 202 and 203. In some implementations, the predetermined event may be a determination by the eNB 2 that user data transmission using at least one data logical channel (i.e., a DRB) needs to be enhanced. Additionally or alternatively, the predetermined event may be a determination by the eNB 2 that resource allocation for at least one data logical channel (i.e., an SRB) needs to be reduced.

In some implementations, the predetermined event may be reception of a signalling message from another network node. The other network node may be a control node (e.g., a Mobility Management Entity (MME)) in a core network (i.e., an EPC). The other network node may be a Mobile Edge Computing (MEC) server. The European Telecommunications Standards Institute (ETSI) has started standardization of the MEC. The MEC server is disposed while being integrated with a RAN node. Specifically, the MEC server can be disposed in a 3GPP eNodeB site, a 3G Radio Network Controller (RNC) site, or a multi-technology cell aggregation site.

In this embodiment, the MEC server may be disposed in the RAN so as to directly communicate with the eNB 2 (i.e., without traversing the core network (i.e., the EPC)). The MEC server can also be referred to as an edge server. The MEC server is configured to provide at least one of computing resources and storage resources (or storage capacities) for edge computing related to a service or an application directed to one or more UEs 1. In some implementations, the MEC server may provide a hosting environment for MEC applications. The MEC server may further have a part of the functions of the core network. For example, the MEC server may have the Serving Gateway (S-GW) or S/P-GW function and terminate an EPS bearer of a UE 1 using the MEC. The MEC architecture is similar to a Network Function Virtualization (NFV) architecture. Accordingly, the MEC server may host network functions including a virtualized S/P-GW (vS/P-GW) as well as MEC applications.

In step 202 in FIG. 2, in response to the predetermined event, the eNB 2 reduces a priority parameter (e.g., a priority, or a PBR, or both) of a logical channel(s) (or SRB(s)) of a specific UE 1 from its initial value (or its standard value). The process for reducing the priority parameter of the logical channel(s) (or the SRB (s)) may be performed for at least one control logical channel of one UE 1. Alternatively, this process may be performed per UEs (i.e., per UE group). For example, this process may be performed for a plurality of UEs having the same specific UE type.

In step 203, the eNB 2 applies the reduced priority parameter to this logical channel(s) (or SRB(s)) of the specific UE 1 and handles priorities among a plurality of logical channels (or RBs) of the specific UE 1. The plurality of logical channels include at least one control logical channel (or SRB) and at least one data logical channel (or DRB).

Each control logical channel is used for transmission of a control message between the UE 1 and the eNB 2. This control message may be used for radio resource control between the UE 1 and the eNB 2 or may be used for transfer of an NAS message transmitted between the UE 1 and the core network. Specifically, this control message may be an RRC message. This RRC message may be an RRC message carrying an NAS message. Meanwhile, each data logical channel is used for transmission of user data of any UE 1. For example, the eNB 2 may reduce the priority or the PBR or both of SRB1 from its initial value (or its standard value). Additionally or alternatively, the eNB 2 may reduce the priority or the PBR or both of SRB2 from its initial value (or its standard value).

The priority parameter of a logical channel is taken into account in priority handling among logical channels performed in at least one of the UE 1 and the eNB 2. For example, the priority parameter of a logical channel may include a priority or a prioritized bit rate (PBR), or both. Additionally or alternatively, the priority parameter of a logical channel may include a PBR and a bucket size duration (BSD).

In some implementations, the eNB 2 may take priorities and PBRs of logical channels into account in scheduling of UL resources or DL resources to a plurality of UEs 1. For example, in time-domain scheduling, a scheduler in the eNB 2 may prioritize a plurality of UEs 1 and select one or more UEs 1 to be scheduled in each transmission period (e.g., each LTE subframe). To calculate a priority-related metric for each UE 1 to be used in the prioritization among the plurality of UEs 1, the scheduler in the eNB 2 may use the priority parameter(s) of one or more logical channels of each UE 1. For example, the scheduler in eNB 2 may preferentially select a UE 1 whose logical channel has a transmission rate lower than its PBR to be scheduled in the current transmission period.

In some implementations, the UE 1 may take the priority parameter (e.g., a priority, or a PBR, or both) of a logical channel into account in a Logical Channel Prioritization (LCP) procedure for generating a UL transport block (i.e., a UL MAC PDU). Similarly, in some implementations, the eNB 2 may take the priority parameter (e.g., a priority, or a PBR, or both) of a logical channel into account in a Logical Channel Prioritization (LCP) procedure for generating a DL transport block (i.e., a DLMAC PDU).

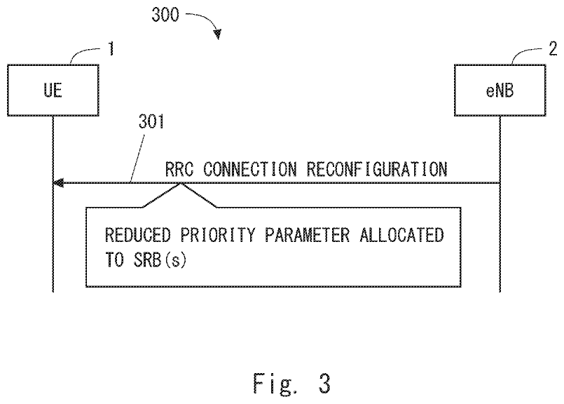

FIG. 3 is a sequence diagram showing a process 300 that is an example of operations performed by the UE 1 and the eNB 2. In step 301, the eNB 2 transmits to the UE 1 an RRC message indicating a reduced priority parameter (e.g., a priority, or a PBR, or both) to be assigned to at least one control logical channel (or SRB). As shown in FIG. 3, this RRC message may be an RRC CONNECTION RECONFIGURATION message. Upon receiving this RRC message, the UE 1 updates the priority parameter of the at least one control logical channel (or SRB) in its LCP procedure.

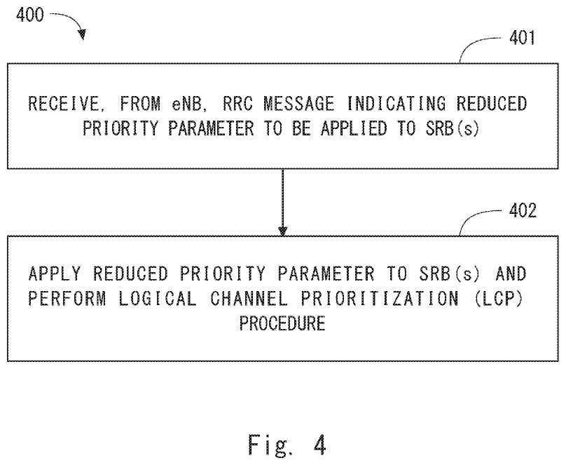

FIG. 4 is a flowchart showing a process 400 that is an example of an operation performed by the UE 1. In step 401, the UE 1 receives from the eNB 2 an RRC message indicating a reduced priority parameter (e.g., a priority, or a PBR, or both) to be assigned to at least one control logical channel (or SRB). In step 402, the UE 1 applies the reduced priority parameter to the SRB(s) and performs the LCP procedure to generate a UL transport block.

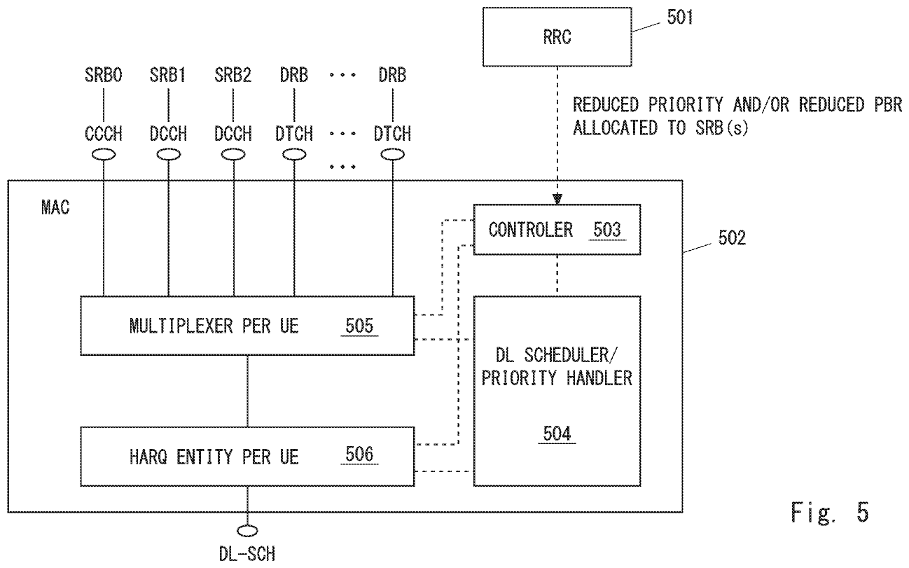

FIG. 5 is a block diagram showing a configuration example of the eNB 2 related to DL transmission. An RRC layer (or an RRC module) 501 determines to reduce a priority or a PBR or both of at least one control logical channel (e.g., SRB0 (CCCH), SRB1 (DCCH), or SRB2 (DCCH)) of a specific UE 1, and sets a reduced priority or a reduced PBR or both in a MAC sublayer (or a MAC module) 502.

The MAC sublayer 502 includes a controller 503, a DL scheduler 504, a multiplexer 505, and a Hybrid Automatic Repeat reQuest (HARQ) entity 506. Although FIG. 5 shows only the multiplexer 505 and the HARQ entity 506 for one UE 1, the MAC sublayer 502 includes a plurality of multiplexers 505 and a plurality of HARQ entities 506 corresponding to a plurality of UEs 1.

The controller 503 communicates with the RRC layer 501 and receives from the RRC layer 501 the reduced priority or the reduced PBR, or both, to be assigned to at least one control logical channel (e.g., SRB0 (CCCH), SRB1 (DCCH), or SRB2 (DCCH)) of the specific UE 1. The controller 503 sets the received priority and PBR in the DL scheduler 504.

The DL scheduler 504 schedules DL transmission performed by a plurality of UEs 1 in the current transmission period (i.e., the current subframe) at least partly based on buffer states of one or more DL logical channels of each UE 1 and a quality state of a DL channel of each UE 1. The quality state of a DL channel is obtained from a Channel Quality Information (CQI) report from each UE 1. The DL scheduler 504 may take other information and other constraints into account for the DL scheduling. For example, the DL scheduler 504 may take account of a priority of a logical channel of each UE 1 and a QoS requirement (e.g., a PBR) of a logical channel of each UE 1. The DL scheduler 504 may use either or both of the above-described reduced priority or reduced PBR for a control logical channel of the specific UE 1. For example, the reduced priority or the reduced PBR or both may be used as a weight factor to calculate a scheduling metric of the specific UE 1.

Further, in an LCP procedure for generating a DL transport block (i.e., a DL MAC PDU) for the specific UE 1, the DL scheduler 504 may apply the reduced priority or the reduced PBR or both to a control logical channel. The DL LCP procedure may be similar to the UL LCP procedure. The result of the LCP is used by the multiplexer 505 for the specific UE 1 to generate a DL transport block.

The multiplexer 505 generates a transport block (i.e., a MAC PDU) to be transmitted in the current transmission period according to the result of the LCP by the DL scheduler 504. The HARQ entity 506 is in charge of a transmission HARQ operation. The transmission HARQ operation includes transmission and retransmission of a transport block, and reception and processing of ACK/NACK signaling.

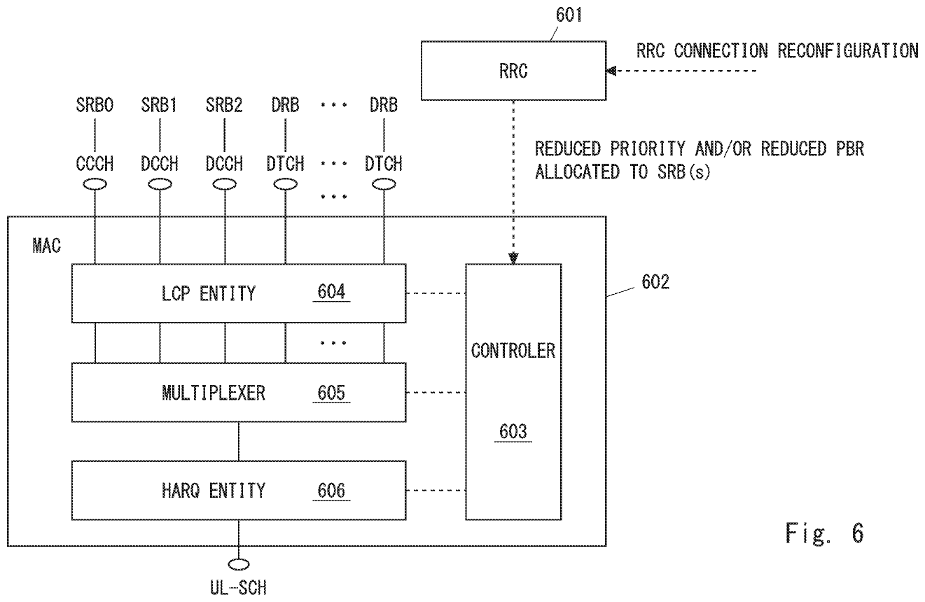

FIG. 6 is a block diagram showing a configuration example of the UE 1 related to UL transmission. An RRC layer (or an RRC module) 601 receives, from the RRC layer 501 of the eNB 2, an RRC message indicting either or both of a reduced priority and a reduced PBR of at least one control logical channel (e.g., SRB0 (CCCH), SRB1 (DCCH), or SRB2 (DCCH)). The RRC layer 601 of the UE 1 sets the reduced priority or the reduced PBR or both in a MAC sublayer (or a MAC module) 602.

The MAC sublayer 602 includes a controller 603, an LCP entity 604, a multiplexer 605, and a Hybrid Automatic Repeat reQuest (HARQ) entity 606. The controller 603 communicates with the RRC layer 601 and receives from the RRC layer 601 the reduced priority or the reduced PBR or both, to be assigned to at least one control logical channel (e.g., SRB0 (CCCH), SRB1 (DCCH), or SRB2 (DCCH)). The controller 603 sets the received priority and the PBR in the LCP entity 604.

The LCP entity 604 performs an LCP procedure according to the priorities and PBRs of logical channels set by the controller 603. The multiplexer 605 multiplexes data segments (i.e., RLC PDUs) from a plurality of logical channels according to the result of the LCP and generates one transport block (i.e., a MAC PDU). The HARQ entity 606 is in charge of a transmission HARQ operation. The transmission HARQ operation includes transmission and retransmission of a transport block, and reception and processing of ACK/NACK signaling.

As already described, in the existing LTE, priority parameters (e.g., priorities, or PBRs, or both) of SRB0 (CCCH), SRB1 (DCCH), and SRB2 (DCCH) are set to their respective standard values (or initial values). That is, the standard values of SRB0 (CCCH), SRB1 (DCCH), and SRB2 (DCCH) are 1, 1, and 3, respectively. The value of a priority is an integer from 1 to 16. Further, the smaller the value, the higher the priority. The standard values of the PBRs of SRB0 (CCCH), SRB1 (DCCH), and SRB2 (DCCH) are all “infinity”. If the PBR of a logical channel (or a radio bearer) is set to “infinity”, a MAC entity of the UE 1 shall allocate resources to all the data of this logical channels that is available for transmission before meeting the PBRs of lower-priority logical channels.

In contrast to this, as understood from the above descriptions, the eNB 2 according to this embodiment is configured to reduce the priority parameter (e.g., a priority, or a PBR, or both) of at least one control logical channel (or SRB) of the specific UE 1 from its standard value (or its initial value). For example, the eNB 2 may update the priority of at least one control logical channel (or SRB) of the specific UE 1 so that it becomes equal to or lower than the priority of at least one data logical channel (or DRB). In this way, the eNB 2 can reduce C-plane traffic (i.e., RRC messages or NAS messages). In other words, the eNB 2 can facilitate resource allocation for U-plane traffic.

More specifically, the eNB 2 may make the priority of at least one control logical channel (or SRB) of the specific UE 1 equal to the lowest value (i.e., the highest priority) among the priorities of one or more data logical channels (DRBs) configured in this specific UE 1. In this way, it is possible to handle C-plane traffic of the specific UE 1 according to the priority of U-plane traffic of this specific UE 1.

Additionally or alternatively, the eNB 2 may set the PBR of at least one control logical channel (or SRB) of the specific UE 1 to a finite value (e.g., kBps0, kBps8, kBps16, kBps32, kBps64, kBps128, or kBps256). The value kBps0 corresponds to 0 kB/s, the value kBps8 corresponds to 8 kB/s, the value kBps16 corresponds to 16 kB/s, and so on. By setting the PBR of an SRB to a finite value, it is possible to limit resources allocated to this SRB in the first round of the LCP procedure. Accordingly, setting the PBR of an SRB to a finite value can contribute to reducing resource allocation for C-plane traffic or increasing resource allocation for U-plane traffic.

The eNB 2 may reduce the priority of the SRB1 (DCCH) or the SRB2 (DCCH) or both. The SRB1 is used for transmission of a number of RRC messages. Reducing the priority of the SRB1 can thus contribute to reducing C-plane traffic (i.e., RRC messages) that the eNB 2 should process. Meanwhile, the SRB2 is used mainly for transmission of NAS messages. Reducing the priority of the SRB2 can thus contribute to reducing C-plane traffic (i.e., NAS messages) that the core network should process.

The eNB 2 may reduce the priority of the SRB0 (CCCH). The SRB0 and the CCCH are used to transmit RRC messages for establishing or reestablishing an RRC connection. Such RRC messages include an RRC Connection Request (UL), an RRC Connection Reestablishment Request (UL), an RRC Connection Setup (DL), an RRC Connection Reject (DL), an RRC Connection Reestablishment (DL), and an RRC Connection Reestablishment reject (DL). For example, to prioritize data transmission performed by a certain UE 1, the eNB 2 may reduce the priority of the SRB0 of other UEs 1. In this case, the eNB 2 may take the reduced priority of the SRB0 into account in scheduling for resource allocation for a plurality of UEs 1.

The eNB 2 may configure a specific control logical channel (or SRB) that is used to transmit only a specific RRC message or a specific NAS message between the eNB 2 and a specific UE 1. Then, the eNB 2 may reduce the priority or the PBR or both of this specific control logical channel from its standard value. In an example, the specific control logical channel may be used to transmit a specific RRC message or a specific NAS message that is relatively delay tolerant. In this way, it is possible to selectively reduce the priority or the PBR of specific C-plane traffic that is relatively delay tolerant. Alternatively, the specific control logical channel may be used to transmit a specific RRC message or a specific NAS message that has a large data size or is frequently transmitted. In this way, it is possible to contribute to reducing a load on the UE 1, the eNB 2, or the core network and also contribute to improving the fairness of radio resource allocation.

For example, the specific control logical channel may be used to transmit an RRC message containing a Handover command. Alternatively, the specific control logical channel may be used to transmit a specific NAS message (e.g., an Attach Request (UL), a Detach Request (UL), a Detach Accept (UL), a Service Request (UL), a Tracking Area Update (TAU) Request (UL), a TAU Complete (UL), a Detach Request (DL), a Detach Accept (DL), a Service Reject (DL), or a TAU Accept (DL)). Alternatively, the specific control logical channel may be used to transmit a specific RRC message (e.g., an RRC Connection Release (DL), a DL Information Transfer (DL), or a UL Information Transfer (UL)).

At least one of the UE 1 and the eNB 2 may operate as described below to selectively apply the reduced priority parameter (e.g., the reduced priority, or the reduced PBR, or both) only for a specific RRC or NAS message. In some implementations, a module in the MAC layer of the eNB 2 (e.g., a UL scheduler, a DL scheduler, or a multiplexer) inspects data segments (i.e., RLC PDUs) stored in a transmission buffer for each control logical channel (e.g., SRB0, SRB1, or DRB2) and detects a specific data segment containing the specific RRC or NAS message. The eNB 2 may inspect data segments received from the transmission buffer to detect the specific data segment. The inspection of data segments may be performed by using an existing Deep Packet Inspection (DPI) or a similar technique. Then, the eNB 2 selectively applies the reduced priority parameter (e.g., the reduced priority, or the reduced PBR, or both) only to the detected specific data segment.

The UE 1 may operate in a manner similar to that of the eNB 2. Specifically, a module in the MAC layer of the UE 1 (e.g., a controller, an LCP entity, or a multiplexer) inspects data segments (i.e., RLC PDUs) stored in a transmission buffer for each control logical channel (e.g., SRB0, SRB1, or DRB2) and detects a specific data segment containing the specific RRC or NAS message. Then, the UE 1 selectively applies the reduced priority parameter (e.g., the reduced priority, or the reduced PBR, or both) only to the detected specific data segment.

### Second Embodiment

This embodiment provides a modified example of the operation performed by the eNB 2 described in the first embodiment. A configuration example of a mobile communication network according to this embodiment is similar to that shown in FIG. 1. In this embodiment, the eNB 2 changes a priority parameter (e.g., a priority, or a PBR, or both) of at least one control logical channel of a specific UE 1 in response to receiving a signalling message from another network node 3. As already described in the first embodiment, the network node 3 may be a control node (e.g., an MME) in the core network (i.e., the EPC) or an MEC server.

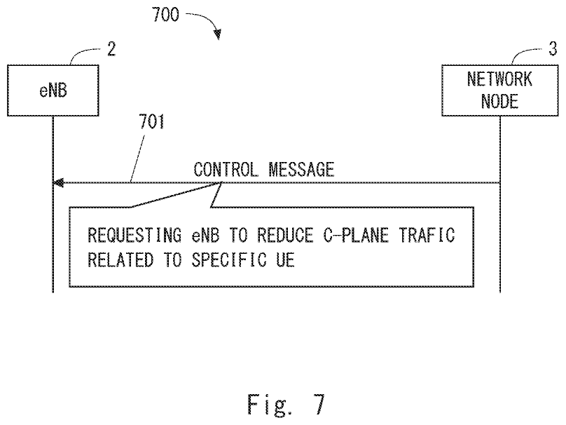

FIG. 7 is a sequence diagram showing a process 700 that is an example of operations performed by the eNB 2 and the network node 3. In step 701, the network node 3 sends a signalling message to the eNB 2. This signalling message triggers the eNB 2 to reduce the priority parameter (e.g., the priority, or the PBR, or both) of at least one control logical channel (e.g., SRB0 (CCCH), SRB1 (DCCH), or SRB2 (DCCH)) of a specific UE 1, which is used for transmission of an RRC message, from a standard value (or an initial value). The at least one control logical channel is used to transmit control messages between the UE 1 and the eNB 2. The control message may be an RRC message. This RRC message may be an RRC message for carrying a NAS message. Upon receiving the signalling message from the network node 3, the eNB 2 updates the priority parameter of the control logical channel of the specific UE 1.

In some implementations, upon receiving the signalling message from the network node 3, the eNB 2 may determine the reduced priority parameter (e.g., the reduced priority, or the reduced PBR, or both) of the control logical channel of the specific UE 1. In this case, as shown in FIG. 7, the signalling message may request the eNB 2 to reduce C-plane traffic (e.g., RRC messages or NAS messages) of the specific UE 1. Alternatively, the signalling message may request the eNB 2 to reduce resource allocation for at least one control logical channel of the specific UE 1. Alternatively, the signalling message may request the eNB 2 to enhance user data transmission using at least one data logical channel (or DRB (DTCH)) of the specific UE 1.

In some implementations, the signalling message may explicitly indicate the reduced priority parameter of at least one control logical channel (e.g., the priority, or the PBR, or both) of the specific UE 1. In this case, the eNB 2 may determine whether to accept the reducing of the priority parameter requested by the network node 3.

In some implementations, the signalling message may designate a period when an action in the RAN (i.e., the eNB 2) on C-plane traffic of the specific UE 1 (i.e., reducing either or both of the priority and the PBR of the control logical channel) is required.

In some implementations, the signalling message may indicate an identifier of one UE, an identifier of a plurality of UEs (i.e., a UE group), or an identifier of a UE type. These identifiers are used by the eNB 2 to specify one or more UEs 1 of which the priority parameter of a control logical channel is to be changed.

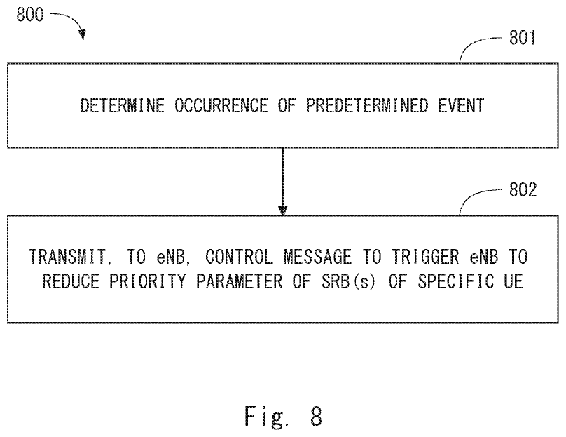

FIG. 8 is a flowchart showing a process 800 that is an example of an operation performed by the network node 3. In step 801, the network node 3 determines an occurrence of a predetermined event. The occurrence of the predetermined event triggers the network node 3 to perform a process in step 802. In step 802, the network node 3 transmits to the eNB 2 a signalling message to trigger the eNB 2 to reduce the priority parameter (e.g., the priority, or the PBR, or both) of at least one control logical channel of a specific UE 1.

In some implementations, the predetermined event in step 801 may be a determination by the network node 3 that C-plane message transmission related to the specific UE 1 needs to be restricted. Additionally or alternatively, the predetermined event may be a determination by the network node 3 that user data transmission related to the specific UE 1 needs to be enhanced.

In some implementations, the network node 3 may determine whether to transmit the signalling message related to the specific UE 1 to the eNB 2 based on behavior of this UE 1, a communication characteristic of this UE 1, or a service used by this UE 1. For example, the network node 3 (e.g., an MME) may detect a UE 1 that repeatedly performs attach and detach operations, and then transmit the signalling message related to the detected UE 1 to the eNB 2. Similarly, the network node 3 (e.g., an MME) may detect a UE 1 that frequently performs state changes between an IDLE state (ECM-IDLE) and a CONNECTED state (ECM-CONNECTED), and then transmit the signalling message related to the detected UE 1 to the eNB 2. Alternatively, the network node 3 (e.g., an MEC server) may detect a UE 1 that is using a predetermined MEC application whose user data transmission is desirably to be prioritized, and then transmits the signalling message related to the detected UE 1 to the eNB 2.

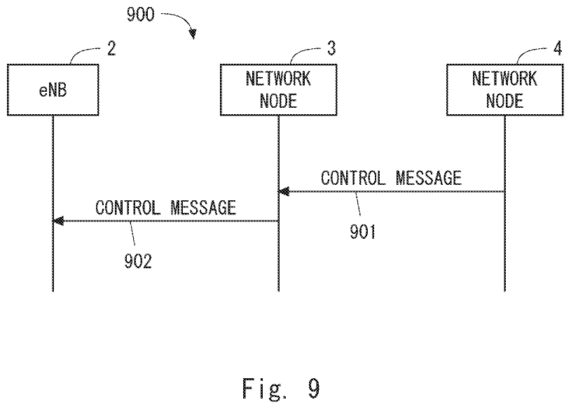

Note that as shown in FIG. 9, the network node 3 may transmit the above-described signalling message (i.e., signalling message 902) to the eNB 2 in response to receiving a signalling message 901 from still another network node 4. The network node 4 may be, for example, a Home Subscriber Server (HSS), a Service Capability Exposure Function (SCEF) entity, or a Policy and Charging Rule Function (PCRF) entity.

According to this embodiment, the network node 3, such as an MME or an MEC server, can control the priority of a control logical channel (or signaling radio bearer) in the RAN (i.e., the eNB 2).

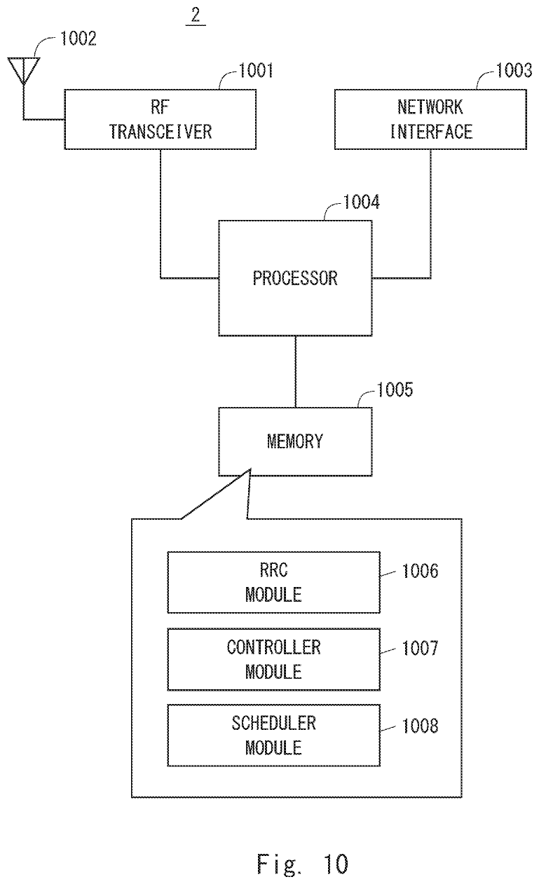

Lastly, configuration examples of the UE 1, the eNB 2, and the network node 3 according to the above embodiments will be described hereinafter. FIG. 10 is a block diagram showing a configuration example of the eNB 2. As shown in FIG. 10, the eNB 2 includes an RF transceiver 1001, a network interface 1003, a processor 1004, and a memory 1005. The RF transceiver 1001 performs analog RF signal processing to communicate with the UE 1. The RF transceiver 1001 may include a plurality of transceivers. The RF transceiver 1001 is connected to an antenna 1002 and the processor 1004. In some implementations, the RF transceiver 1001 receives modulated symbol data (or OFDM symbol data) from the processor 1004, generates a transmission RF signal, and supplies the generated transmission RF signal to the antenna 1002. Further, the RF transceiver 1001 generates a baseband reception signal based on a reception RF signal received by the antenna 1002 and supplies this signal to the processor 1004. Note that as described above, the eNB 2 may be a BBU (or a REC) used in the C-RAN architecture. In this case, the eNB 2 may not include the RF transceiver 1001.

The network interface 1003 is used to communicate with a network node (e.g., a MME, an S/P-GW, and an MEC server). The network interface 1003 may include, for example, a network interface card (NIC) conforming to the IEEE 802.3 series.

The processor 1004 performs digital baseband signal processing (i.e., data-plane processing) and control-plane processing for radio communication. For example, in the case of LTE or LTE-Advanced, the digital baseband signal processing performed by the processor 1004 may include signal processing of the PDCP layer, RLC layer, MAC layer, and PHY layer. Further, the control-plane processing performed by the processor 1004 may include processing of the Si protocol, RRC protocol, and MAC CEs.

The processor 1004 may include a plurality of processors. For example, the processor 1004 may include a modem-processor (e.g., DSP) that performs the digital baseband signal processing, and a protocol-stack-processor (e.g., CPU or MPU) that performs the control-plane processing.

The memory 1005 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disk drive, or a combination thereof. The memory 1005 may include a storage located apart from the processor 1004. In this case, the processor 1004 may access the memory 1005 through the network interface 1003 or an I/O interface (not shown).

The memory 1005 may store software modules (or computer programs) including instructions and data to perform processing by the eNB 2 described in the above embodiments. In some implementations, the processor 1004 may be configured to load the software module from the memory 1005 and execute the loaded software module, thereby performing the processing of the eNB 2 described in the above embodiments with reference to the drawings.

In the example shown in FIG. 10, the memory 1005 stores an RRC module 1006, a controller module 1007, and a scheduler module 1008. The processor 1004 can function as the RRC layer 501, the control 503, and the DL scheduler 504 shown in FIG. 5 by loading and executing the RRC module 1006, the controller module 1007, and the scheduler module 1008.

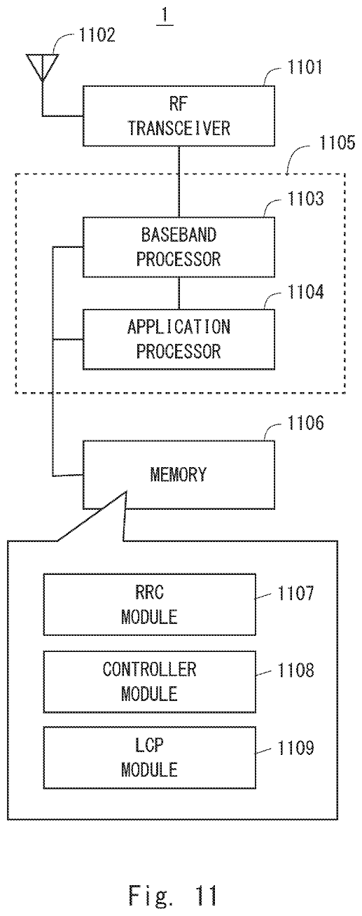

FIG. 11 is a block diagram showing a configuration example of the UE 1. A Radio Frequency (RF) transceiver 1101 performs analog RF signal processing to communicate with the eNB 2. The analog RF signal processing performed by the RF transceiver 1101 includes a frequency up-conversion, a frequency down-conversion, and amplification. The RF transceiver 1101 is connected to an antenna 1102 and the baseband processor 1103. That is, the RF transceiver 1101 receives modulated symbol data (or OFDM symbol data) from the baseband processor 1103, generates a transmission RF signal, and supplies the generated transmission RF signal to the antenna 1102. Further, the RF transceiver 1101 generates a baseband reception signal based on a reception RF signal received by the antenna 1102 and supplies this signal to the baseband processor 1103.

The baseband processor 1103 performs digital baseband signal processing (data-plane processing) and control-plane processing for radio communication. The digital baseband signal processing includes (a) data compression/restoration, (b) data segmentation/concatenation, (c) transmission format (transmission frame) generation/decomposition, (d) transmission path encoding/decoding, (e) modulation (symbol mapping), (f) OFDM symbol data (baseband OFDM signal) generation by Inverse Fast Fourier Transform (IFFT), and so on. Meanwhile, the control-plane processing includes communication management in a layer 1 (e.g., transmission power control), a layer 2 (e.g., radio resource management and a hybrid automatic repeat request (HARQ)), and a layer 3 (e.g., attach, mobility, and signaling related to telephone-call management).

For example, in the case of the LTE, the digital baseband signal processing performed by the baseband processor 1103 may include signal processing in a Packet Data Convergence Protocol (PDCP) layer, a Radio Link Control (RLC) layer, a Medium Access Control (MAC) layer, and a Physical (PHY) layer. Further, the control-plane processing performed by the baseband processor 1103 may include a Non-Access Stratum (NAS) protocol, an RRC protocol, and MAC Control Element (MAC CE) processing.

The baseband processor 1103 may include a modem-processor (e.g., a Digital Signal Processor (DSP)) that performs the digital baseband signal processing and a protocol-stack-processor (e.g., a Central Processing Unit (CPU), or a Micro Processing Unit (MPU)) that performs the control-plane processing. In this case, the protocol stack processor, which performs the control-plane processing, may be integrated with an application processor 1104 described in the following.

The application processor 1104 is also referred to as a CPU, an MPU, a microprocessor, or a processor core. The application processor 1104 may include a plurality of processors (or processor cores). The application processor 1104 loads a system software program (Operating System (OS)) and various application programs (e.g., voice call application, WEB browser, mailer, camera operation application, and music player application) from a memory 1106 or from another memory (not shown) and executes these programs, thereby providing various functions of the UE 1.

In some implementations, as represented by the dashed line (1105) in FIG. 11, the baseband processor 1103 and the application processor 1104 may be integrated on a single chip. In other words, the baseband processor 1103 and the application processor 1104 may be implemented in a single System on Chip (SoC) device 1105. A SoC device may be referred to as a system Large Scale Integration (LSI) or a chipset.

The memory 1106 is a volatile memory, a nonvolatile memory, or a combination thereof. The memory 1106 may include a plurality of physically-independent memory devices. The volatile memory is, for example, a Static Random Access Memory (SRAM), a Dynamic RAM (DRAM), or a combination thereof. The nonvolatile memory is, for example, a Read Only Memory (MROM), an Electrically Erasable Programmable ROM (EEPROM), a flash memory, a hard disk drive, or any combination thereof. For example, the memory 1106 may include an external memory device that can be accessed by the baseband processor 1103, the application processor 1104, and the SoC 1105. The memory 1106 may include an internal memory device that is integrated in the baseband processor 1103, the application processor 1104, or the SoC 1105. Further, the memory 1106 may include a memory disposed in a Universal Integrated Circuit Card (UICC).

The memory 1106 may store one or more software modules (or computer programs) including a set of instructions and data for performing processing performed by the UE 1 described in the above embodiments. In some implementations, the baseband processor 1103 or the application processor 1104 may be configured to load these software modules from the memory 1106 and execute the loaded software modules, thereby performing the processing of the UE 1 described in the above embodiments with reference to the drawings.

In the example shown in FIG. 11, the memory 1106 stores an RRC module 1107, a controller module 1108, and an LCP module 1109. The baseband processor 1103 or the application processor 1104 loads and executes the RRC module 1107, the controller module 1108, and the LCP module 1109, thereby functioning as the RRC layer 601, the control 603, and the LCP entity 604 shown in FIG. 6.

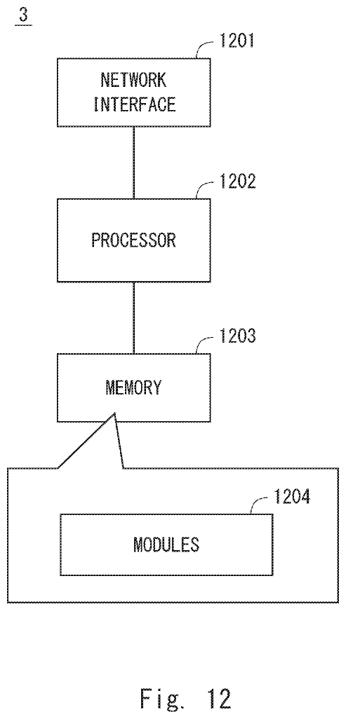

FIG. 12 is a block diagram showing a configuration example of the network node 3. The network node 4 may have a configuration similar to that shown in FIG. 12. As shown in FIG. 12, the network node 3 includes a network interface 1201, a processor 1202, and a memory 1203. The network interface 1201 is used to communicate with the eNB 2 and other network nodes. The network interface 1201 may include, for example, a network interface card (NIC) conforming to the IEEE 802.3 series.

The processor 1202 loads software modules (or computer programs) 1204 from the memory 1203 and executes the loaded software modules, thereby performing processing of the network node 3 described in the above embodiments. The processor 1202 may be, for example, a microprocessor, an MPU, or a CPU. The processor 1202 may include a plurality of processors.

The memory 1203 is formed by a combination of a volatile memory and a nonvolatile memory. The memory 1203 may include a storage remotely disposed from the processor 1202. In this case, the processor 1202 may access the memory 1203 through an I/O interface (not shown).

As described above with reference to FIGS. 10 to 12, in some implementations, each of the processors included in the UE 1, the eNB 2, and the network node 3 according to the above-described embodiment executes one or more programs including a set of instructions to cause a computer to perform an algorithm described above with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

### Other Embodiments

Each of the above embodiments may be used individually, or two or more of the embodiments may be appropriately combined with one another.

As already described, the above-described embodiment may be applied to a mobile communication network other than those in accordance with the LTE. For example, when the above-described embodiment is applied to 3GPP UMTS, the eNB 2 may be an RNC.

Further, the above-described embodiments are merely examples of applications of the technical ideas obtained by the inventor. These technical ideas are not limited to the above-described embodiments and various modifications can be made thereto.

For example, the whole or part of the embodiments disclosed above can be described as, but not limited to, the following supplementary notes.

### (Supplementary Note 1)

A radio access network node comprising:

a memory; and

at least one processor coupled to the memory and configured to reduce a priority parameter of at least one control logical channel of a first radio terminal from an initial value in response to a predetermined event, the at least one control logical channel being used for transmission of a control message between the radio access network node and the first radio terminal, wherein

the priority parameter affects priority handling among a plurality of logical channels of the first radio terminal performed in at least one of the radio access network node and the first radio terminal, and

the plurality of logical channels include the at least one control logical channel and at least one data logical channel of the first radio terminal used for transmission of user data of the first radio terminal.

### (Supplementary Note 2)

The radio access network node described in Supplementary note 1, wherein the priority parameter is taken into account in at least one of resource scheduling in the radio access network node, multiplexing of a plurality of downlink logical channels of the first radio terminal in the radio access network node, and multiplexing of a plurality of uplink logical channels of the first radio terminal in the first radio terminal.

### (Supplementary Note 3)

The radio access network node described in Supplementary note 1 or 2, wherein the priority parameter is used in a Logical Channel Prioritization (LCP) procedure in the first radio terminal.

### (Supplementary Note 4)

The radio access network node described in any one of Supplementary notes 1 to 3, wherein the at least one processor is configured to change the priority parameter of the at least one control logical channel so that the priority parameter of the at least one control logical channel becomes equal to or lower than a priority parameter of the at least one data logical channel.

### (Supplementary Note 5)

The radio access network node described in any one of Supplementary notes 1 to 4, wherein the at least one processor is configured to transmit a signalling message indicating the reduced priority parameter to the first radio terminal.

### (Supplementary Note 6)

The radio access network node described in any one of Supplementary notes 1 to 5, wherein the predetermined event includes reception of a signalling message from another network node.

### (Supplementary Note 7)

The radio access network node described in Supplementary note 6, wherein the other network node is a control node in a core network or is a mobile edge computing (MEC) server.

### (Supplementary Note 8)

The radio access network node described in Supplementary note 6 or 7, wherein the radio access network node is a base station.

### (Supplementary Note 9)

The radio access network node described in any one of Supplementary notes 6 to 8, wherein the signalling message requests the radio access network node to enhance user data transmission using the at least one data logical channel.

### (Supplementary Note 10)

The radio access network node described in any one of Supplementary notes 6 to 8, wherein the signalling message requests the radio access network node to reduce resource allocation for the at least one control logical channel.

### (Supplementary Note 11)

The radio access network node described in any one of Supplementary notes 1 to 5, wherein the predetermined event includes a determination by the radio access network node to enhance user data transmission using the at least one data logical channel.

### (Supplementary Note 12)

The radio access network node described in any one of Supplementary notes 1 to 5, wherein the predetermined event includes a determination by the radio access network node to reduce resource allocation for the at least one control logical channel.

### (Supplementary Note 13)

The radio access network node described in any one of Supplementary notes 1 to 12, wherein each of the at least one control logical channel is a specific control logical channel used only for transmission of a specific Radio Resource Control (RRC) message or a specific Non-Access Stratum (NAS) message.

### (Supplementary Note 14)

The radio access network node described in any one of Supplementary notes 1 to 12, wherein the at least one processor is configured to selectively apply the reduced priority parameter to a specific data segment that is included in a plurality of data segments of the at least one control logical channel and contains a specific Radio Resource Control (RRC) message or a specific Non-Access Stratum (NAS) message.

### (Supplementary Note 15)

The radio access network node described in any one of Supplementary notes 1 to 14, wherein the priority parameter includes at least one of a priority and a prioritized bit rate (PBR).

### (Supplementary Note 16)

The radio access network node described in any one of Supplementary notes 1 to 15, wherein each of the at least one control logical channel is a Dedicated Control Channel (DCCH) in accordance with 3GPP Long Term Evolution (LTE), LTE-Advanced, or LTE-Advanced Pro.

### (Supplementary Note 17)

A method performed in a radio access network node, the method comprising:

determining an occurrence of a predetermined event; and

in response to the predetermined event, reducing a priority parameter of at least one control logical channel of a first radio terminal from an initial value, the at least one control logical channel being used for transmission of a control message between the radio access network node and the first radio terminal, wherein

the priority parameter affects priority handling among a plurality of logical channels of the first radio terminal performed in at least one of the radio access network node and the first radio terminal, and the plurality of logical channels include the at least one control logical channel and at least one data logical channel of the first radio terminal used for transmission of user data of the first radio terminal.

### (Supplementary Note 18)

A radio terminal comprising:

a memory; and

at least one processor coupled to the memory and configured to:
receive from a radio access network node a signalling message indicating that a priority parameter of at least one control logical channel used for transmission of a control message between the radio terminal and the radio access network node is to be reduced from an initial value; and
apply the reduced priority parameter to priority handling among a plurality of logical channels of the radio terminal performed in the radio terminal, wherein

the plurality of logical channels include the at least one control logical channel and at least one data logical channel of the radio terminal used for transmission of user data of the radio terminal.

### (Supplementary Note 19)

The radio terminal described in Supplementary note 18, wherein the at least one processor is configured to selectively apply the reduced priority parameter to a specific data segment that is included in a plurality of data segments of the at least one control logical channel and contains a specific Radio Resource Control (RRC) message or a specific Non-Access Stratum (NAS) message.

### (Supplementary Note 20)

The radio terminal described in Supplementary note 18 or 19, wherein the at least one processor is configured to apply the reduced priority parameter to a Logical Channel Prioritization (LCP) procedure in the radio terminal.

### (Supplementary Note 21)

The radio terminal described in any one of Supplementary notes 18 to 20, wherein the signalling message indicates that the priority parameter of the at least one control logical channel is changed so that the priority parameter of the at least one control logical channel becomes equal to or lower than a priority parameter of the at least one data logical channel.

### (Supplementary Note 22)

The radio terminal described in any one of Supplementary notes 18 to 21, wherein each of the at least one control logical channel is a specific control logical channel used only for transmission of a specific Radio Resource Control (RRC) message or a specific Non-Access Stratum (NAS) message.

### (Supplementary Note 23)

The radio terminal described in any one of Supplementary notes 18 to 22, wherein the priority parameter includes at least one of a priority and a prioritized bit rate (PBR).

### (Supplementary Note 24)

The radio terminal described in any one of Supplementary notes 18 to 23, wherein each of the at least one control logical channel is a Dedicated Control Channel (DCCH) in accordance with 3GPP Long Term Evolution (LTE), LTE-Advanced, or LTE-Advanced Pro.

### (Supplementary Note 25)

A method performed in a radio terminal, the method comprising:

receiving from a radio access network node a signalling message indicating that a priority parameter of at least one control logical channel used for transmission of a control message between the radio terminal and the radio access network node is to be reduced from an initial value; and

applying the reduced priority parameter to priority handling among a plurality of logical channels of the radio terminal performed in the radio terminal, wherein

the plurality of logical channels include the at least one control logical channel and at least one data logical channel of the radio terminal used for transmission of user data of the radio terminal.

### (Supplementary Note 26)

A network node comprising:

a memory; and

at least one processor coupled to the memory and configured to transmit a first signalling message to a base station, wherein

the first signalling message triggers the base station to reduce a priority parameter of at least one control logical channel of a first radio terminal, used for transmission of a control message between the base station and the first radio terminal, from an initial value,

the priority parameter affects priority handling among a plurality of logical channels of the first radio terminal performed in at least one of the base station and the first radio terminal, and

the plurality of logical channels include the at least one control logical channel and at least one data logical channel of the first radio terminal used for transmission of user data of the first radio terminal.

### (Supplementary Note 27)

The network node described in Supplementary note 26, wherein the at least one processor is configured to transmit the first signalling message to the base station in response to a determination by the network node to restrict control-plane message transmission related to the first radio terminal.

### (Supplementary Note 28)

The network node described in Supplementary note 26 or 27, wherein the at least one processor is configured to transmit the first signalling message to the base station in response to a determination by the network node to enhance user data transmission related to the first radio terminal.

### (Supplementary Note 29)

The network node described in any one of Supplementary notes 26 to 28, wherein the at least one processor is configured to determine whether to transmit the first signalling message to the base station based on behavior of the first radio terminal, a communication characteristic of the first radio terminal, or a service used by the first radio terminal.

### (Supplementary Note 30)

The network node described in any one of Supplementary notes 26 to 29, wherein the at least one processor is configured to transmit the first signalling message to the base station in response to receiving a second signalling message from another network node.

### (Supplementary Note 31)

The network node described in Supplementary note 30, wherein the other network node is a Home Subscriber Server (HSS), a Service Capability Exposure Function (SCEF) entity, or a Policy and Charging Rule Function (PCRF) entity.

### (Supplementary Note 32)

The network node described in any one of Supplementary notes 26 to 31, wherein the priority parameter is taken into account in at least one of resource scheduling in the base station, multiplexing of a plurality of downlink logical channels of the first radio terminal in the base station, and multiplexing of a plurality of uplink logical channels of the first radio terminal in the first radio terminal.

### (Supplementary Note 33)

The network node described in any one of Supplementary notes 26 to 32, wherein the priority parameter is used in a Logical Channel Prioritization (LCP) procedure in the first radio terminal.

### (Supplementary Note 34)

The network node described in any one of Supplementary notes 26 to 33, wherein the network node is a control node in a core network or is a mobile edge computing (MEC) server.

### (Supplementary Note 35)

The network node described in any one of Supplementary notes 26 to 34, wherein the priority parameter includes at least one of a priority and a prioritized bit rate (PBR).

### (Supplementary Note 36)

A method performed in a network node, the method comprising transmitting a first signalling message to a base station, wherein the first signalling message triggers the base station to reduce a priority parameter of at least one control logical channel of a first radio terminal, used for transmission of a control message between the base station and the first radio terminal, from an initial value, the priority parameter affects priority handling among a plurality of logical channels of the first radio terminal performed in at least one of the base station and the first radio terminal, and the plurality of logical channels include the at least one control logical channel and at least one data logical channel of the first radio terminal used for transmission of user data of the first radio terminal.

### (Supplementary Note 37)

A program for causing a computer to perform a method in a radio access network node, the method comprising:

determining an occurrence of a predetermined event; and

in response to the predetermined event, reducing a priority parameter of at least one control logical channel of a first radio terminal from an initial value, the at least one control logical channel being used for transmission of a control message between the radio access network node and the first radio terminal, wherein

the priority parameter affects priority handling among a plurality of logical channels of the first radio terminal performed in at least one of the radio access network node and the first radio terminal, and

the plurality of logical channels include the at least one control logical channel and at least one data logical channel of the first radio terminal used for transmission of user data of the first radio terminal.

### (Supplementary Note 38)

A program for causing a computer to perform a method in a radio terminal, the method comprising:

receiving from a radio access network node a signalling message indicating that a priority parameter of at least one control logical channel used for transmission of a control message between the radio terminal and the radio access network node is to be reduced from an initial value; and

applying the reduced priority parameter to priority handling among a plurality of logical channels of the radio terminal performed in the radio terminal, wherein

the plurality of logical channels include the at least one control logical channel and at least one data logical channel of the radio terminal used for transmission of user data of the radio terminal.

### (Supplementary Note 39)

A program for causing a computer to perform a method in a network node, the method comprising transmitting a first signalling message to a base station, wherein

the first signalling message triggers the base station to reduce a priority parameter of at least one control logical channel of a first radio terminal, used for transmission of a control message between the base station and the first radio terminal, from an initial value,

the priority parameter affects priority handling among a plurality of logical channels of the first radio terminal performed in at least one of the base station and the first radio terminal, and

the plurality of logical channels include the at least one control logical channel and at least one data logical channel of the first radio terminal used for transmission of user data of the first radio terminal.

This application is based upon and claims the benefit of priority from Japanese patent application No. 2016-072423, filed on Mar. 31, 2016, the disclosure of which is incorporated herein in its entirety by reference.

### REFERENCE SIGNS LIST

1 UE
2 eNB
3 NETWORK NODE
4 NETWORK NODE
501 RRC MODULE
503 CONTROLLER
504 DOWNLINK SCHEDULER
601 RRC MODULE
603 CONTROLLER
604 LCP ENTITY

What is claimed is:

1. A radio access network node comprising:
a memory; and
at least one processor coupled to the memory and configured to reduce a priority parameter of at least one control logical channel of a first radio terminal from an initial value in response to a predetermined event, the at least one control logical channel being used for transmission of a control message between the radio access network node and the first radio terminal, wherein
the priority parameter affects priority handling among a plurality of logical channels of the first radio terminal performed in at least one of the radio access network node and the first radio terminal, and
the plurality of logical channels include the at least one control logical channel and at least one data logical channel of the first radio terminal used for transmission of user data of the first radio terminal.

2. The radio access network node according to claim 1, wherein the priority parameter is taken into account in at least one of resource scheduling in the radio access network node, multiplexing of a plurality of downlink logical channels of the first radio terminal in the radio access network node, and multiplexing of a plurality of uplink logical channels of the first radio terminal in the first radio terminal.

3. The radio access network node according to claim 1, wherein the priority parameter is used in a Logical Channel Prioritization (LCP) procedure in the first radio terminal.

4. The radio access network node according to claim 1, wherein the at least one processor is configured to change the priority parameter of the at least one control logical channel so that the priority parameter of the at least one control logical channel becomes equal to or lower than a priority parameter of the at least one data logical channel.

5. The radio access network node according to claim 1, wherein the at least one processor is configured to transmit a signalling message indicating the reduced priority parameter to the first radio terminal.

6. The radio access network node according to claim 1, wherein the predetermined event includes reception of a signalling message from another network node.

7. The radio access network node according to claim 6, wherein the other network node is a control node in a core network or is a mobile edge computing (MEC) server.

8. The radio access network node according to claim 6, wherein the radio access network node is a base station.

9. The radio access network node according to claim 6, wherein the signalling message requests the radio access network node to enhance user data transmission using the at least one data logical channel.

10. The radio access network node according to claim 6, wherein the signalling message requests the radio access network node to reduce resource allocation for the at least one control logical channel.

11. The radio access network node according claim 1, wherein the predetermined event includes a determination by the radio access network node to enhance user data transmission using the at least one data logical channel.

12. The radio access network node according to claim 1, wherein the predetermined event includes a determination by the radio access network node to reduce resource allocation for the at least one control logical channel.

13. (canceled)

14. The radio access network node according to claim 1, wherein the at least one processor is configured to selectively apply the reduced priority parameter to a specific data segment that is included in a plurality of data segments of the at least one control logical channel and contains a specific Radio Resource Control (RRC) message or a Non-Access Stratum (NAS) message.

15. The radio access network node according to claim 1, wherein the priority parameter includes at least one of a priority and a prioritized bit rate (PBR).

16. (canceled)

17. A method performed in a radio access network node, the method comprising:
determining an occurrence of a predetermined event; and
in response to the predetermined event, reducing a priority parameter of at least one control logical channel of a first radio terminal from an initial value, the at least one control logical channel being used for transmission of a control message between the radio access network node and the first radio terminal, wherein
the priority parameter affects priority handling among a plurality of logical channels of the first radio terminal performed in at least one of the radio access network node and the first radio terminal, and
the plurality of logical channels include the at least one control logical channel and at least one data logical channel of the first radio terminal used for transmission of user data of the first radio terminal.

18. A radio terminal comprising:
a memory; and
at least one processor coupled to the memory and configured to:
receive from a radio access network node a signalling message indicating that a priority parameter of at least one control logical channel used for transmission of a control message between the radio terminal and the radio access network node is to be reduced from an initial value; and
apply the reduced priority parameter to priority handling among a plurality of logical channels of the radio terminal performed in the radio terminal, wherein
the plurality of logical channels include the at least one control logical channel and at least one data logical channel of the radio terminal used for transmission of user data of the radio terminal.

19. The radio terminal according to claim 18, wherein the at least one processor is configured to selectively apply the reduced priority parameter to a specific data segment that is included in a plurality of data segments of the at least one control logical channel and contains a specific Radio Resource Control (RRC) message or a specific Non-Access Stratum (NAS) message.

20. The radio terminal according to claim 18, wherein the at least one processor is configured to apply the reduced priority parameter to a Logical Channel Prioritization (LCP) procedure in the radio terminal.

21. The radio terminal according to claim 18, wherein the signalling message indicates that the priority parameter of the at least one control logical channel is changed so that the priority parameter of the at least one control logical channel becomes equal to or lower than a priority parameter of the at least one data logical channel.

22. The radio terminal according to claim 18, wherein each of the at least one control logical channel is a specific control logical channel used only for transmission of a specific Radio Resource Control (RRC) message or a specific Non-Access Stratum (NAS) message.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)
